(19) United States
(12) Patent Application Publication
(10) Pub. No.: US 2012/0209731 A1
(43) Pub. Date: Aug. 16, 2012

(54) COMPUTER-BASED FUND TRANSMITTAL SYSTEM AND METHOD

(76) Inventors: MICK CONLIN, Sioux Falls, SD (US); BRADLEY C. HANSON, Harrisburg, SD (US); SCOTT GALIT, New York, NY (US)

(21) Appl. No.: 13/295,559

(22) Filed: Nov. 14, 2011

Related U.S. Application Data
(63) Continuation of application No. 11/927,878, filed on Oct. 30, 2007, now abandoned.
(60) Provisional application No. 60/863,535, filed on Oct. 30, 2006.

(51) Int. Cl. G06Q 40/00

(52) U.S. Cl. 705/16; 705/44

(57) ABSTRACT

A fund transmittal system includes a first agent portal module for receiving funds from a first entity to initiate a first fund transaction. The system includes a transaction network and a transaction processor. The first agent portal module routes the first fund transaction to the transaction processor via the transaction network. The transaction processor supplies an authorization code associated with the first fund transaction to the first entity. The first entity provides the authorization code to a second entity. The system includes a second agent portal module that receives the authorization code from the second entity to initiate a second fund transaction. The second agent portal module routes the authorization code to the transaction processor via the transaction network. The transaction processor approves the second fund transaction in accordance with the authorization code. Upon approval, the second agent portal module supplies the funds to the second entity.

### PRIORITY

This application is a continuation of U.S. patent application Ser. No. 11/927,878, filed Oct. 30, 2007, which claims the benefit under 35 U.S.C. §119(e) of U.S. Provisional Application Ser. No. 60/863,535, filed Oct. 30, 2006, the entire contents of both are expressly incorporated herein by reference.

### BACKGROUND

1. Field of the Invention

The present invention relates to fund transfer systems. More particularly, the present invention relates to a computer-based system and method for transmitting funds from a first entity to a second entity.

2. Background Information

An increasingly common problem involves moving funds between countries or between bank accounts. Conventionally, one is required to contact a financial institution and request a wire-transfer of funds to another institution. Such a process is lengthy, often taking from several days to weeks to accomplish. Further, requested transfers often may not go through as expected or intended. Even when requested transfers do go through successfully, it sometimes occurs that funds are not handled properly by the institution receiving the funds.

There are several conventional methods of transferring or wiring money, the most common being a transfer service offered by WESTERN UNION™. To send money via WESTERN UNION™, a customer must travel to a WESTERN UNION™ office or agent location, and present cash or equivalent funds in the amount to be transferred plus a service fee. The sender is required to fill out a detailed transfer request form for each transaction that is then automatically or manually entered into the WESTERN UNION™ system. Such a method is very labor-intensive and time-consuming, particularly if the sender makes frequent transfers.

These and other such wire-transfer methods can incur delays in the input, transmission, authentication, and execution by the recipient business. For example, such methods generally require the requesting party to provide identification information that is entered and then transmitted by the local financial institution so that it can be authenticated and approved by the customer's home financial institution. Thus, several opportunities are created for errors to occur that can subsequently result in a delay in the customer's request. Should errors occur, manual intervention and investigation then become necessary.

The transfer of funds between countries is especially complicated. For example, such transactions are closely regulated by various governments. Accordingly, any attempt to simplify the transfer of funds must ensure that the fund transfer system complies with pertinent government regulations.

Yet another complication with the international transfer of funds results from the use of different currencies. In particular, because the transferred funds should be in the form of a currency different than that used in the country of the transferring institution, it is necessary for the requesting party to be made aware of the applicable exchange rate, preferably before the transaction is consummated. However, such a practice usually involves the customer having to calculate the equivalent value of the foreign currency.

Currently, most consumer banking institutions utilize a network of automated teller machines (ATMs) that permit customers to more readily transfer funds between accounts. Such ATMs permit the customer to perform these transactions substantially in real-time (without any necessary time lag for settlement). Some systems now utilize ATM networks to permit a customer while in one country to access his or her account in another country. However, these systems do not provide the benefit of enabling one to conveniently transfer funds from an individual or organization in a first country for use by an individual or organization in a second country.

Money Transfers often originate or are received in retail environments. However, as those of ordinary skill in the art of the present invention can appreciate, there are limitations and complexities to “Open Network” systems (Visa®, MasterCard®, among others), that make it cumbersome to create new products and extend them to retailers.

As those of ordinary skill in the art of the present invention understand, additional financial systems exist within retail environment for transferring funds. For example, a point of sale activation (hereinafter referred to as “POSA”) system coexists with Open Network systems in retail locations. POSA systems have an electronic connection to the retailers that enables consumers to purchase value, often for prepaid mobile phones, and perform other services at retail. These systems may (or may not) coexist on the same hardware device or connect into the same register as the Open Network system. Typically POSA systems have different software, etc., that are used on the device to power the applications. These POSA systems then typically connect to a POSA server, which manages the products and services that are offered. These POSA systems are often more flexible than Open Network systems and can more easily accommodate new developments and innovation. In addition, the companies that manage them are often more entrepreneurial and typically also have risk management policies and a settlement relationship with retailers.

### SUMMARY OF THE INVENTION

A computer-based fund transmittal system and method are disclosed. In accordance with exemplary embodiments of the present invention, according to a first aspect of the present invention, a system for transmitting funds from a first entity to a second entity includes a first agent portal module. The first agent portal module is configured to receive the funds from the first entity for initiating a first fund transaction. The system includes a transaction network in communication with the first agent portal module. The system includes a transaction processor in communication with the transaction network. The first fund transaction is routed to the transaction processor via the transaction network. The transaction processor is configured to supply an authorization code associated with the first fund transaction to the first entity via the transaction network and the first agent portal module. The first entity is configured to provide the authorization code to the second entity. The system includes a second agent portal module in communication with the transaction network. The second agent portal module is configured to receive the authorization code from the second entity for initiating a second fund transaction. The authorization code is routed to the transaction processor via the transaction network. The transaction processor is configured to approve the second fund transaction in accordance with the authorization code. Upon approval, the second agent portal module is configured to supply the funds to the second entity.

According to the first aspect, the transaction network can be configured to select the transaction processor for processing the first and second fund transactions. The transaction network can comprise a settlement module. The settlement module can be configured to settle the first fund transaction with the first agent portal module. For example, the first fund transaction can be settled by the settlement module by debiting funds from an account associated with the first agent portal module and crediting an account associated with the transaction processor. The settlement module can be configured to settle the second fund transaction with the second agent portal module. For example, the second fund transaction can be settled by the settlement module by debiting funds from an account associated with the transaction processor and crediting an account associated with the second agent portal module.

According to the first aspect, the first agent portal module can comprise a first user interface module. The first user interface module can be configured to interface the first entity to the first agent portal module. For example, the first user interface module can be configured to display a graphical interface through which the first entity interacts with the first agent portal module. The second agent portal module can comprise a second user interface module. The second user interface module can be configured to interface the second entity to the second agent portal module. For example, the second user interface module can be configured to display a graphical interface through which the second entity interacts with the second agent portal module. The system can include a database module in communication with the transaction processor. For example, the database module can be configured to store transaction information associated with the first and second fund transactions. According to an exemplary embodiment of the first aspect, the funds can be stored at the transaction processor.

According to the first aspect, the funds received from the first entity can comprise a first currency, and the funds supplied to the second entity can comprise a second currency. Consequently, the transaction network can be configured to convert the funds from the first currency to the second currency. According to an alternative exemplary embodiment of the first aspect, the funds can stored at the transaction processor in the second currency. The first agent portal module can be configured to receive an indication from the first entity of a country to which the funds will be transmitted. The transaction network can be configured to determine the second currency into which the first currency can be to be converted in accordance with the country indication. The first agent portal module can comprise a first unique identifier. The first fund transaction can be associated with the first unique identifier. The first unique identifier can comprise a first bank identification number (BIN). The second agent portal module can comprise a second unique identifier. The second fund transaction can be associated with the second unique identifier. The second unique identifier can comprise a second BIN.

According to the first aspect, the transaction processor can be configured to perform a compliance check associated with the first fund transaction prior to supplying an authorization code. The transaction processor can be configured to perform a compliance check associated with the second fund transaction prior to approving the second fund transaction. The first agent portal module can be configured to receive registration information from the first entity for registering with the system. The first entity can receive a unique registration identifier in response to registering with the system. The unique registration identifier can comprise a personal identification number (PIN). For example, the unique registration identifier can be encoded on an identification card or the like. The first agent portal module can be configured to accept the identification card from the first entity. The first agent portal module can be configured to decode the unique registration identifier from the identification card for initiating the first fund transaction. The second agent portal module can be configured to receive registration information from the second entity for registering with the system. The second entity can receive a unique registration identifier in response to registering with the system. The first entity can be in communication with the first agent portal module, and the second entity can be in communication with the second agent portal module. The first agent portal module can be located in a first remote location, and the second agent portal module can be located in a second remote location. The first entity can be configured to provide the authorization code to the second entity via a communication network.

According to a second aspect of the present invention, a remittance system includes a first fund transaction module. The first fund transaction module is configured to receive funds in a first currency for initiating a first fund transaction. The system includes a settlement module in communication with the first fund transaction module. The settlement module is configured to convert the funds in the first currency to a second currency. The system includes a transaction processor module in communication with the settlement module. The transaction processor module is configured to supply a fund retrieval code associated with the first fund transaction to the first fund transaction module. The system includes a second fund transaction module in communication with the settlement module. The second fund transaction module is configured to receive the fund retrieval code for initiating a second fund transaction. The transaction processor module is configured to approve the second fund transaction in accordance with the fund retrieval code. Upon approval, the second fund transaction module is configured to dispense the funds in the second currency to a recipient.

According to the second aspect, the first fund transaction module can be configured to route the first fund transaction to the settlement module. The fund retrieval code can be provided to the recipient via a communication module. The settlement module can be configured to select the transaction processor module for processing the first and second fund transactions. The second fund transaction module can be configured to route the fund retrieval code received from the recipient to the transaction processor module via the settlement module. The settlement module can be configured to settle the first fund transaction with the first fund transaction module, and the settlement module can be configured to settle the second fund transaction with the second fund transaction module. The first fund transaction module can include a first user interface module. The second fund transaction module can include a second user interface module. The system can include a storage module in communication with the transaction processor module. The transaction processor module can be configured to store the funds in the second currency. The first fund transaction module can be configured to receive an indication of a country to which the funds will be transmitted. The settlement module can be configured to determine the second currency into which the first currency can be to be converted in accordance with the country indication.

According to a third aspect of the present invention, a method of transmitting funds from a first entity to a second entity includes the steps of: a.) receiving the funds from the first entity at a first location to initiate a first fund transaction; b.) supplying an authorization code associated with the first fund transaction to the first entity; c.) providing the authorization code to the second entity by the first entity; d.) receiving the authorization code from the second entity at a second location to initiate a second fund transaction; e.) approving the second fund transaction in accordance with the authorization code; and f.) supplying the funds to the second entity at the second location.

According to the third aspect, the method can include the steps of: g.) routing the first fund transaction from step (a) for processing; h.) routing the authorization code from step (d) for processing; i.) settling the first fund transaction; j.) settling the second fund transaction; k.) storing transaction information associated with the first and second fund transactions; and l.) storing the funds after step (b). According to an exemplary embodiment of the third aspect, the funds received from the first entity can comprise a first currency, and the funds supplied to the second entity can comprise a second currency. Consequently, the method can include the steps of: m.) converting the funds from the first currency to the second currency; and n.) storing the funds in the second currency. Step (m) can include the step of: m1.) determining the second currency into which the first currency can be to be converted in accordance with the country indication.

According to the third aspect, step (a) can comprise the step of a1.) receiving an indication from the first entity of a country to which the funds will be transmitted. The first fund transaction can be associated with a first unique identifier. The first unique identifier can comprise a first BIN. The second fund transaction can be associated with a second unique identifier. The second unique identifier can comprise a second BIN. The method can include the steps of: o.) performing a compliance check associated with the first fund transaction prior to supplying an authorization code; and p.) performing a compliance check associated with the second fund transaction prior to approving the second fund transaction. Step (a) can include the step of: a2.) receiving registration information from the first entity. The first entity can receive a unique registration identifier in response to step (a2). The unique registration identifier can comprise a PIN or the like. The unique registration identifier can be encoded. The method can include the step of: q.) decoding the unique registration identifier to initiate the first fund transaction. Step (d) can include the step of: d1.) receiving registration information from the second entity. The second entity can receive a unique registration identifier in response to step (d1). The first location can comprise a first remote location, and the second location can comprise a second remote location.

According to a fourth aspect of the present invention, a remittance method includes the steps of: a.) receiving funds in a first currency at a first location to initiate a first fund transaction; b.) converting the funds in the first currency to a second currency; c.) supplying a fund retrieval code associated with the first fund transaction to the first location; d.) settling the first fund transaction; e.) receiving the fund retrieval code at a second location to initiate a second fund transaction; f.) approving the second fund transaction in accordance with the fund retrieval code; g.) dispensing the funds in the second currency to a recipient at the second location; and h.) settling the second fund transaction.

According to the fourth aspect, step (a) can comprise the steps of: a1.) receiving an indication of a country to which the funds will be transmitted; and a2.) determining the second currency into which the first currency can be to be converted in accordance with the country indication. The method can include the step of: i.) storing the funds in the second currency after step (b).

According to the fifth aspect, a method of transmitting funds includes the step of: a.) initiating a first fund transaction. Step (a) comprises the steps of: a1.) receiving the funds from a first entity at a first location; and a2.) supplying a fund retrieval code associated with the first fund transaction to the first entity. The method includes the steps of: b.) providing the fund retrieval code to a second entity by the first entity; and c.) initiating a second fund transaction. Step (c) comprises the steps of: c1.) receiving the fund retrieval code from the second entity at a second location; c2.) approving the second fund transaction in accordance with the fund retrieval code; and c3.) supplying the funds to the second entity at the second location.

According to a sixth aspect of the present invention, a system for transmitting funds between a first entity and a second entity includes a first interfacing structure. The first interfacing structure is configured to receive the funds from the first entity for initiating a first fund transaction. The system includes a networking transactions structure in communication with the first interfacing structure. The system includes a processing transaction structure in communication with the transaction networking structure. The first fund transaction is routed to the transaction processing structure via the transaction networking structure. The transaction processing structure is configured to supply an authorization code associated with the first fund transaction to the first entity via the transaction networking structure and the first interfacing structure. The first entity is configured to provide the authorization code to the second entity. The system includes a second structure for interfacing in communication with the transaction networking structure. The second interfacing structure is configured to receive the authorization code from the second entity for initiating a second fund transaction. The authorization code is routed to the transaction processing structure via the transaction networking structure. The transaction processing structure is configured to approve the second fund transaction in accordance with the authorization code. Upon approval, the second interfacing structure is configured to supply the funds to the second entity.

According to the sixth aspect, the transaction networking structure can be configured to select the transaction processing structure for processing the first and second fund transactions. The transaction networking structure can include a settling transaction structure. The transaction settling structure can be configured to settle the first fund transaction with the first interfacing structure. For example, the first fund transaction can be settled by the transaction settling structure by debiting funds from an account associated with the first interfacing structure and crediting an account associated with the transaction processing structure. The transaction settling structure can be configured to settle the second fund transaction with the second interfacing structure. For example, the second fund transaction can be settled by the transaction settling structure by debiting funds from an account associated with the transaction processing structure and crediting an account associated with the second interfacing structure. The first interfacing structure can be configured to interface to the first entity. For example, the first interfacing structure can be configured to display a graphical interface through which the first entity interacts with the first interfacing structure. The second interfacing structure can be configured to interface to the second entity. For example, the second interfacing structure can be configured to display a graphical interface through which the second entity interacts with the second interfacing structure.

According to the sixth aspect, the system can include a storing information structure in communication with the transaction processing structure. The information storing structure can be configured to store transaction information associated with the first and second fund transactions. According to an exemplary embodiment of the sixth aspect, the funds can be stored at the transaction processing structure. However, the funds received from the first entity can comprise a first currency, and the funds supplied to the second entity can comprise a second currency. The transaction networking structure can be configured to convert the funds from the first currency to the second currency. According to an alternative exemplary embodiment of the sixth aspect, the funds can be stored at the transaction processing structure in the second currency. The first interfacing structure can be configured to receive an indication from the first entity of a country to which the funds will be transmitted. The transaction networking structure can be configured to determine the second currency into which the first currency can be to be converted in accordance with the country indication.

According to the sixth aspect, the first interfacing structure can comprise a first unique identifier, and the first fund transaction can be associated with the first unique identifier. For example, the first unique identifier can comprise a first BIN or the like. The second interfacing structure can comprise a second unique identifier, and the second fund transaction can be associated with the second unique identifier. For example, the second unique identifier can comprise a second BIN or the like. The transaction processing structure can be configured to perform a compliance check associated with the first fund transaction prior to supplying an authorization code. The transaction processing structure can be configured to perform a compliance check associated with the second fund transaction prior to approving the second fund transaction.

According to the sixth aspect, the first interfacing structure can be configured to receive registration information from the first entity for registering with the system. The first entity can receive a unique registration identifier in response to registering with the system. For example, the unique registration identifier can comprise a PIN or the like. The unique registration identifier can be encoded on an identification device. The first interfacing structure can be configured to accept the identification device from the first entity. The first interfacing structure can be configured to decode the unique registration identifier from the identification device for initiating the first fund transaction. The second interfacing structure can be configured to receive registration information from the second entity for registering with the system. The second entity can receive a unique registration identifier in response to registering with the system. The first entity can be in communication with the first interfacing structure, and the second entity can be in communication with the second interfacing structure. The first interfacing structure can be located in a first remote location, and the second interfacing structure can be located in a second remote location. The first entity can be configured to provide the authorization code to the second entity via a communicating structure.

According to a seventh aspect of the present invention, a remittance system includes a first performing fund transaction structure. The first fund transaction performing structure is configured to receive funds in a first currency for initiating a first fund transaction. The system includes a settling transaction structure in communication with the first fund transaction performing structure. The transaction settling structure is configured to convert the funds in the first currency to a second currency. The system includes processing transaction structure in communication with the transaction settling structure. The transaction processing structure is configured to supply a fund retrieval code associated with the first fund transaction to the first fund transaction performing structure. The system includes a second performing fund transaction structure in communication with the transaction settling structure. The second fund transaction performing structure is configured to receive the fund retrieval code for initiating a second fund transaction. The transaction processing structure is configured to approve the second fund transaction in accordance with the fund retrieval code. Upon approval, the second fund transaction performing structure is configured to dispense the funds in the second currency to a recipient.

According to the seventh aspect, the first fund transaction performing structure can be configured to route the first fund transaction to the transaction settling structure. The fund retrieval code can be provided to the recipient via a communicating structure. The transaction settling structure can be configured to select the transaction processing structure for processing the first and second fund transactions. The second fund transaction performing structure can be configured to route the fund retrieval code received from the recipient to the transaction processing structure via the transaction settling structure. The transaction settling structure can be configured to settle the first fund transaction with the first fund transaction performing structure. The transaction settling structure can be configured to settle the second fund transaction with the second fund transaction performing structure. The first fund transaction performing structure can comprise a first interfacing structure. The second fund transaction performing structure can comprise a second interfacing structure. The system can include a storing information structure in communication with the transaction processing structure. The transaction processing structure can be configured to store the funds in the second currency. The first fund transaction performing structure can be configured to receive an indication of a country to which the funds will be transmitted. The transaction settling structure can be configured to determine the second currency into which the first currency can be to be converted in accordance with the country indication.

According to still a further aspect of the present invention, a system and method are provided that enables retailers to participate in the global money transfer system and enables consumers to send and receive funds at retail locations (i.e., retail stores (Wal-Mart®, among others). According to the additional exemplary embodiment of the present invention, the computer based fund transmittal system, described in detail above, which, according to an embodiment of the present invention uses the Open Network system, is connected to a point-of-sale activation (POSA) system to access retailers. A POSA server then operates as an acquiring processor (as far as the Open Networks are concerned), that enables the money transfer products contemplated herein to be offered to retailers and consumers through the POSA connection into the retailer. The POSA connection back to the Open Network enables global standardization across POSA's and other partners.

According to an eighth aspect of the present invention, a system for transmitting funds from a first entity to a second entity, comprising: a first agent portal module, wherein the first agent portal module is configured to receive the funds from the first entity for initiating a first fund transaction; a transaction network in communication with the first agent portal module; a transaction processor in communication with the transaction network, wherein the first fund transaction is routed to the transaction processor via the transaction network, wherein the transaction processor is configured to supply an authorization code associated with the first fund transaction to the first entity via the transaction network and the first agent portal module, and wherein the first entity is configured to provide the authorization code to the second entity; and a second agent portal module in communication with the transaction network, wherein the second agent portal module is configured to receive the authorization code from the second entity for initiating a second fund transaction, wherein the authorization code is routed to the transaction processor via the transaction network, wherein the transaction processor is configured to approve the second fund transaction in accordance with the authorization code, and wherein, upon approval, the second agent portal module is configured to supply the funds to the second entity. Still further according to the eighth aspect of the present invention, the system further comprises: a point of sale activation system portal module, wherein the point of sale activation system portal module is configured to receive a message from a customer requesting a transfer of funds; a point of sale activation system network in communication with the point of sale activation system portal module; a point of sale activation system server in communication with the transaction network, point of sale activation system server, and the point of sale activation system module, wherein the point of sale activation system message can be routed to the transaction processor via the transaction network, wherein the transaction processor is configured to supply an authorization code associated with message to the first entity via the transaction network and the first agent portal module, and wherein the first entity is configured to provide the authorization code to the second entity; and a second agent portal module in communication with the transaction network, wherein the second agent portal module is configured to receive the authorization code from the second entity for initiating a second fund transaction, wherein the authorization code is routed to the transaction processor via the transaction network, wherein the transaction processor is configured to approve the second fund transaction in accordance with the authorization code, and wherein, upon approval, the second agent portal module is configured to supply the funds to the customer via the point of sale activation system portal module.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating a system for transmitting funds from a first entity to a second entity, in accordance with an exemplary embodiment of the present invention.

FIG. 2 is a block diagram illustrating a remittance system, in accordance with an alternative exemplary embodiment of the present invention.

FIG. 3 is a flowchart illustrating steps for transmitting funds from a first entity to a second entity, in accordance with an exemplary embodiment of the present invention.

FIG. 4 is a flowchart illustrating steps for a remittance method, in accordance with an exemplary embodiment of the present invention.

FIG. 5 is a diagram illustrating a system for transmitting funds from a first entity to a second entity to a third point of sale activation system, in accordance with an exemplary embodiment of the present invention.

### DETAILED DESCRIPTION OF THE PREFERRED EMBODIMENTS

Exemplary embodiments of the present invention are directed to a computer-based fund transmittal system and method. More particularly, a system and method for transmitting funds from a sender (e.g., an individual or organization) to a receiver (e.g., another individual or organization) are disclosed. According to exemplary embodiments, a first agent (e.g., a retail agent, principal member, financial institution agent, or the like) receives or otherwise collects funds from the sender in a first currency to initiate a first fund transaction. For international transfers, the sender can also specify the country to which the funds are to be transmitted. The first agent routes the first fund transaction to a transaction/settlement network, such as a credit card (e.g., MasterCard, Visa or the like) settlement network. The transaction/settlement network selects or otherwise designates a financial institution (e.g., a bank or the like) as the processor for the transaction. The first fund transaction is sent to the transaction processor for a compliance check (e.g., to ensure compliance with appropriate government regulations) or other like processing. Upon successful compliance, the transaction processor sends an authorization code back to the sender. The authorization code acts as a pick-up or retrieval code for picking up the funds at the destination location by the receiver. The transaction/settlement network settles the first fund transaction with the transaction processor with funds from the first agent. If necessary, the transaction/settlement network can perform a currency exchange to convert the funds from the currency of the originating country to the currency of the destination country. The funds are deposited or otherwise stored at the transaction processor in, for example, the currency of the destination country to await pickup by the receiver.

The sender provides the authorization/pickup code to the receiver (e.g., in the destination country) using any suitable communication medium (e.g., telephone, e-mail, fax or the like). The receiver then provides the authorization/pickup code to a second agent (e.g., a retail agent, Principal Member, financial institution agent, or the like) to initiate a second fund transaction. The authorization/pickup code is routed through the transaction/settlement network to the transaction processor for a compliance check and approval. Once approved, the approval is sent from the transaction processor to the transaction/settlement network and on to the second agent. Upon receiving the approval, the second agent provides or otherwise dispenses the funds to the receiver in the currency of the destination country. The transaction/settlement network settles the second fund transaction with the second agent with funds from the transaction processor. The entire fund transfer transaction is thereby completed. According to exemplary embodiments, the fund transmittal process occurs as two separate transactions. For example, it may not be known when the receiver will pick up the funds in the destination location. In addition, the first and second agents do not settle the transaction with each other directly.

Exemplary embodiments of the present invention can be used for money or fund transfers or other remittance operations from a first individual or organization (e.g., a first bank or other financial institution) to a second individual or organization (e.g., a second bank or other financial institution). For example, exemplary embodiments can be used for performing inter-regional or international fund transfers. For purposes of illustration and not limitation, exemplary embodiments can be used to transfer funds between individuals in different countries. Assume for purposes of illustration that an individual in Country A desires to transfer funds to a second individual in Country B. However, the currency used in Country A is different than the currency used in Country B. Exemplary embodiments of the present invention can accept the funds from the first individual in the currency of Country A, and then convert and store those funds in the currency of Country B for eventual pickup by the second individual using the appropriate authorization/pickup code.

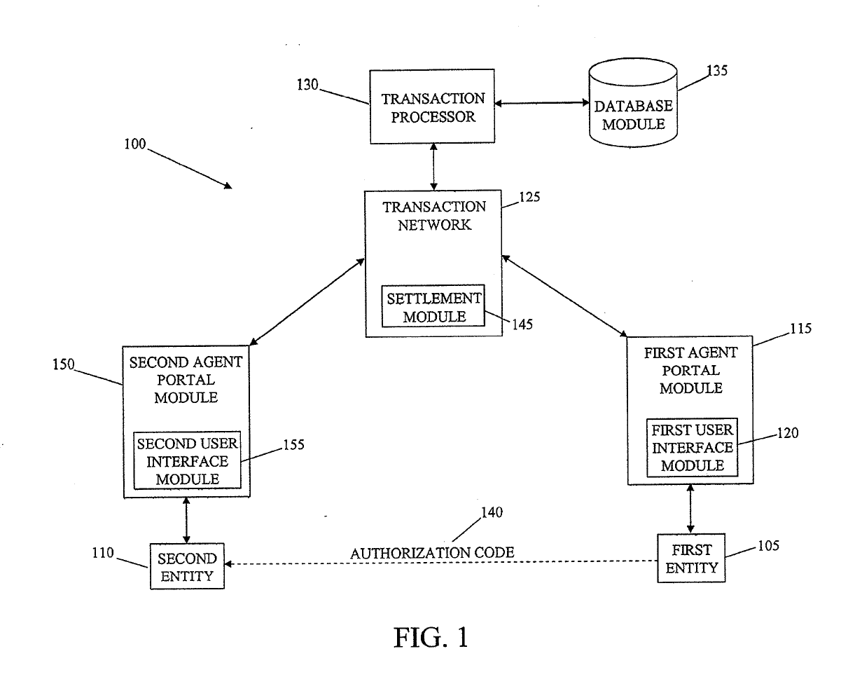

These and other aspects and embodiments of the present invention will now be described in greater detail. FIG. 1 is a diagram illustrating a system 100 for transmitting funds from a first entity 105 to a second entity 110, in accordance with an exemplary embodiment of the present invention. Each of the first and second entities 105 and 110 can comprise any suitable type of entity, including, for example, individuals or other users, companies, financial institutions (e.g., banks), or any other appropriate type of entity that desires to transfer or otherwise transmit money from one entity at one location to another entity at another location. For example, the first and/or second entities 105 and 110 can each comprise a user accessing the system 100 via a personal computer (PC) or other suitable computing device (e.g., a personal digital assistant (PDA) or the like).

The system 100 includes a first agent portal module 115. The first agent portal module 115 is configured to receive funds from the first entity 105 for initiating a first fund transaction. The first agent portal module 115 can be managed or otherwise associated with any suitable type of first agent, such as, for example, a principal member (e.g., of a credit card transaction network, such as, for example, MasterCard, Visa, or the like), a retail agent, a financial institution agent, or other like agent. According to an exemplary embodiment, such first agents can be “signed-up” by or otherwise associated with a principal member. For example, the retail or financial institution agents can be agents of a principal member, and the first entity 105 can go to or otherwise access any of these agents or the principal member to initiate the first fund transaction through the first agent portal module 115.

To uniquely identify the transaction, the first fund transaction can be originated on or otherwise associated with uniquely identifying information. For example, the first agent portal module 115 can comprise a first unique identifier, and the first fund transaction can be associated with the first unique identifier. According to an exemplary embodiment, the first fund transaction can be originated on or otherwise associated with the bank identification number (BIN) of the principal member associated with the first agent portal module 115. Therefore, any agents associated with a given principal member can also use the BIN of the corresponding principal member to originate, or otherwise conduct, and uniquely identify the transaction. Consequently, the first unique identifier can comprise a first BIN, although any unique alphanumeric designation or identifier can be used.

The funds provided to or otherwise collected by the first agent portal module 115 from the first entity 105 can be any suitable type of monetary tender, including, for example, electronic funds, cash, or other suitable tender. To facilitate interaction, the first entity 105 is in communication with the first agent portal module 115. Accordingly, the first agent portal module 115 can include a first user interface module 120. The type of user interface provided by the first user interface module 120 will depend on, for example, the type of transactions accepted by the first agent portal module 115. For example, for electronic fund transfers and the like from the first entity 105, the first user interface module 120 can be configured to interface the first entity 105 (e.g., a bank or other financial institution) to the first agent portal module 115, such as using a suitable computer or other electronic interface through which electronic information is communicated between the first entity 105 and the first agent portal module 115. Alternatively, for cash transactions and the like from the first entity 105, the first user interface module 120 can be configured to display an appropriate graphical user interface (GUI) through which the first entity 105 (e.g., an individual) interacts with the first agent portal module 115. According to such an alternative exemplary embodiment, the first agent portal module 115 can comprise a kiosk-based system, such as an ATM machine or the like, that is configured to accept such cash-based transactions. Merely for purposes of illustration and not limitation, the GUI displayed to the first entity 105 by the first user interface module 120 can be displayed on a suitable screen or monitor of the kiosk or ATM machine.

According to a further alternative exemplary embodiment, if the first entity 105 accesses the first agent portal module 115 via a PC or other remote interface, then the first user interface module 120 can be comprised of an appropriate portal or interface through which the user provides or otherwise enters information for use by the system 100. For example, the first user interface module 120 can be comprised of any suitable type of user interface capable of displaying graphical and/or textual information to a user. For example, the first user interface module 120 can be configured to display graphical and/or textual information generated by the system 100 through a suitable Web browser (e.g., Internet Explorer, Netscape, Firefox, Safari, Opera, or any other suitable Web browser) on any appropriate type of display, such as a computer monitor or other display device (e.g., a personal digital assistant (PDA) or the like portable display). However, the first user interface module 120 can provide any suitable type of electronic, computer, graphical and/or textual interface that is capable of allowing the first entity 105 to interface or otherwise interact with the system 100, depending on the type(s) of transactions supported by the system 100.

The system 100 includes a transaction network 125 in communication with the first agent portal module 115. The transaction network 125 can be any suitable type of financial transaction/settlement network that is capable of processing, routing, and settling the fund transactions according to exemplary embodiments of the present invention. For purposes of illustration and not limitation, the transaction network 125 can comprise a transaction network such as, for example, the MasterCard or Visa networks, or any other suitable type of financial network that is capable of processing such financial transactions regionally and/or internationally.

The system 100 includes a transaction processor 130 in communication with the transaction network 125. The transaction processor 130 can be configured to perform suitable processing on the fund transactions supported by the system 100. According to an exemplary embodiment, the transaction processor 130 can comprise or otherwise be associated with an appropriate financial institution (e.g., a bank, originating depository financial institution (ODFI), or the like) or other suitable organization or entity that is capable of processing such fund transactions. The transaction network 125 is configured to select or otherwise “point to” the transaction processor 130 (e.g., by storing the network, computer, Internet Protocol (IP), or other identifying address of the transaction processor 130) for processing the fund transactions, such as the first fund transaction. Accordingly, the first fund transaction is routed to the transaction processor 130 from the first agent portal module 115 via the transaction network 125. The transaction processor 130 is configured to perform appropriate processing on the first fund transaction. For purposes of illustration and not limitation, the transaction processor 130 can be configured to perform one or more compliance checks on or associated with the first fund transaction to ensure that the transaction complies with, for example, appropriate governmental regulations regarding such transactions.

The transaction processor 130 can perform such processing in any suitable manner. For example, the transaction processor 130 can be comprised of suitable algorithms, Boolean or other logic functions or rules, neural networks, and/or forms of artificial intelligence that are capable of learning information about a fund transaction and, based on that information, process that transaction appropriately. According to one exemplary embodiment, the transaction processor 130 can include appropriate look-up tables that can map fund transactions to corresponding processing tasks. Such look-up tables can be stored in a suitable computer memory or other computer storage device internal to or in communication with the transaction processor 130.

For purposes of illustration and not limitation, the first agent portal module 115 can be configured to receive an indication from the first entity 105 of the country to which the funds will be transmitted (the destination country), and, if not predetermined, the country from which the funds are received (the originating country). Such an indication can be in the form of, for example, a country code or abbreviation. Using such a country indication, the look-up table can include a mapping of countries to governmental regulations applicable to such fund transactions. For example, assume for purposes of illustration that the originating country is predetermined to be the United States (e.g., as the first agent portal module 115 is accessed from within the geopolitical borders of the U.S.). If the first entity 105 desires to transfer funds to Canada (e.g., indicated by the abbreviation of “CA”), then the table can map the country indication of CA to a regulation such as, for example, “the total amount of funds to transfer cannot exceed $10,000.” Any suitable processing can be performed on the fund transactions, and the complexity of such look-up tables will depend on the nature and type of fund transactions and the processing required for each such transaction.

Alternatively, suitable Boolean or other logic or rules can be used by the transaction processor 130 to process the first fund transaction. For example, continuing with the present illustration, IF the originating country is “US” AND the destination country is “CA,” THEN authorize the first fund transaction if the amount to transfer is less than $10,000. The complexity of such logic or rules will depend on the nature and type of the fund transactions and the processing required for such transactions, as well as other like factors. More complex mechanisms, such as neural networks, can be adapted to “learn” how to process such transactions. For example, according to an exemplary embodiment, the transaction processor 130 can “learn” that fund transfers from the U.S. to Canada over $10,000 are prohibited under U.S. banking regulations. Such information can be fed back to the transaction processor 130 to allow such “learning” to take place and to refine these or other processing algorithms.

The system 100 can include a storage or database module 135 in communication with the transaction processor 130. The database module 135 can be configured to maintain or otherwise store any suitable information used or generated by the system 100. For example, the database module 125 can be configured to store transaction information associated with fund transactions, and other suitable information. The database module 135 can be comprised of any suitable type of computer-readable or other computer storage medium capable of storing information in electrical or electronic form.

Once appropriate processing is performed on the first fund transaction by the transaction processor 130, if the fund transaction does not meet all (or substantially all) corresponding processing requirements, a transaction denial message can be forwarded from the transaction processor 130 to the first entity 105 via the transaction network 125 and the first agent portal module 115 (and first user interface module 120). However, if the first fund transaction meets all (or substantially all) processing requirements, then the transaction processor 130 is configured to generate and supply an authorization code or other fund retrieval code 140 associated with the first fund transaction to the first entity 105 via the transaction network 125 and the first agent portal module 115 (and first user interface module 120). The authorization or fund retrieval code 140 comprises a string of identification characters (e.g., alphanumeric characters) of any suitable length that uniquely identifies the first fund transaction. Such a code can be generated in any appropriate manner (e.g., using a random number generator, a look-up table, or other like mechanism or algorithm).

According to exemplary embodiments, the authorization or fund retrieval code 140 that is provided to the first entity 105 acts as the “pickup code” that is used by the second entity 110 to pick up the funds, at the second location, that were collected from the first entity 105 by the first agent portal module 115. Therefore, after the first entity 105 receives the authorization or fund retrieval code 140, the first entity 105 provides the authorization or fund retrieval code 140 to the second entity 110 using any suitable communication network or medium (e.g., telephone, e-mail, fax or the like). According to an exemplary embodiment, the first entity 105 provides the authorization or fund retrieval code 140 to the second entity 110 using a secure means or structure of communication, such as, for example, encrypted e-mail or other suitable form of encrypted or otherwise secure communication. The funds can be stored or otherwise deposited at, for example, the transaction processor 130 or other suitable location to await pickup by the second entity 110.

Although the transaction network 125 can be used as the networking backbone to conduct regional and/or international transfers of funds, the transaction network 125 can also be used to process some or all of the fund transactions supported by the system 100. According to an exemplary embodiment, the transaction network 125 can include a settlement module 145. The settlement module 145 can be configured to settle the first transaction with the first agent portal module 115. For example, the settlement module 145 can settle the first fund transaction by (electronically) debiting funds from an account associated with the first agent portal module 115 and crediting an account associated with the transaction processor 130.

Additionally or alternatively, the system 100 can perform any suitable currency exchange or conversion of the funds. According to an exemplary embodiment, the system 100 supports the transfer of funds from the first entity 105 in a first remote location (e.g., a first country) to the second entity 110 in a second remote location (e.g., a second country). The funds received from the first entity 105 can be in a first currency (e.g., the currency of the first country). However, the second entity 110 can be in another country that may use a different, second currency (e.g., the currency of the second country). Therefore, the second entity 110 may need to pick up or otherwise receive the funds in the second currency. Accordingly, the transaction network 125, using, for example, the settlement module 145, can be configured to convert the funds from the first currency to the second currency using conventional currency exchange algorithms and exchange rates (e.g., supplied from a real-time or substantially real-time information feed from an appropriate financial source). For example, the transaction network 125 (e.g., via the settlement module 145) can be configured to determine the second currency into which the first currency is to be converted in accordance with or otherwise based on the country indication supplied provided by the first entity 105, as discussed previously. For purposes of illustration and not limitation, using look-up tables such as those discussed previously, the transaction network 125 can lookup the exchange rate that corresponds to the country indication, and then multiply the amount of funds by the exchange rate to convert the funds from the first currency into the second currency. According to an alternative exemplary embodiment, however, such currency conversion can be performed by the transaction processor 130. Once converted, the funds can be stored at, for example, the transaction processor 130 in the second currency to facilitate pickup by the second entity 110.

The system 100 includes a second agent portal module 150 in communication with the transaction network 125. The second agent portal module 150 is configured to receive the authorization or fund retrieval code 140 from the second entity 110 for initiating a second fund transaction. The second entity 110 can provide the authorization or fund retrieval code 140 electronically (e.g., through an electronic interface provided by second user interface module 155) or manually (e.g., by entering code numbers into a keypad of a kiosk- or ATM-based system). The second agent portal module 150 can be managed or otherwise associated with any suitable type of second agent, such as, for example, a principal member (e.g., of a credit card transaction network, such as, for example, MasterCard, Visa, or the like), a retail agent, a financial institution agent, or other like agent. According to an exemplary embodiment, such second agents can be “signed-up” by or otherwise associated with a principal member. For example, the retail or financial institution agents can be agents of a principal member, and the second entity 110 can go to any of these agents or the principal member to initiate the second fund transaction through the second agent portal module 150.

To uniquely identify the transaction, the second fund transaction can be originated on or otherwise associated with uniquely identifying information. For example, the second agent portal module 150 can comprise a second unique identifier, and the second fund transaction can be associated with the second unique identifier. According to an exemplary embodiment, the second fund transaction can be originated on or otherwise associated with the BIN of the principal member associated with the second agent portal module 150. Therefore, any agents associated with a given principal member can also use the BIN of the corresponding principal member to originate, or otherwise conduct, and uniquely identify the transaction. Consequently, the second unique identifier can comprise a second BIN, although any unique alphanumeric designation or identifier can be used.

According to exemplary embodiments, the fund transmittal process occurs as two separate transactions, such as, for example, the first fund transaction and the second fund transaction. For example, it may not be known when the second entity 110 will pick up the funds at the destination location, so that the first and second fund transaction do not occur simultaneously or concurrently or even within a short period of each other. Breaking the overall fund transaction into two separate transactions avoids such issues. In addition, the first and second agent portal modules 115 and 150 do not settle the transaction with each other directly (as each transaction is settled with the intervening transaction network 125). Consequently, no special financial processing relationship need exist directly between first and second agent portal modules 115 and 150 (e.g., the first and second agent portal modules 115 and 150 do not need to be associated or otherwise affiliated with the same bank, financial institution or other organization). Accordingly, the system 100 can provide increased flexibility and accessibility for transferring funds between different locations within a region and/or internationally.

To facilitate interaction, the second entity 110 is in communication with the second agent portal module 150. Accordingly, the second agent portal module 150 can include a second user interface module 155. The type of user interface provided by the second user interface module 155 will depend on, for example, the type of transactions accepted by the second agent portal module 150. For example, for electronic fund transfers and the like to the second entity 110, the second user interface module 155 can be configured to interface the second entity 110 (e.g., a bank or other financial institution) to the second agent portal module 150, such as using a suitable computer or other electronic interface through which electronic information is communicated between the second entity 110 and the second agent portal module 150. Alternatively, for cash transactions and the like to the second entity 110, the second user interface module 155 can be configured to display an appropriate GUI through which the second entity 110 (e.g., an individual) interacts with the second agent portal module 150. According to such an alternative exemplary embodiment, the second agent portal module 150 can comprise a kiosk-based system, such as an ATM machine or the like. Merely for purposes of illustration and not limitation, the GUI displayed to the second entity 110 by the second user interface module 155 can be displayed on a suitable screen or monitor of the kiosk or ATM machine.

Of course, the second entity 110 can interface to the second agent portal module 150 via the second user interface module 155 to transfer funds to the first entity 105, as such fund transactions can be performed in either direction between the first and second entities 105 and 110. According to a further alternative exemplary embodiment, if the second entity 110 accesses the second agent portal module 150 via a PC or other remote interface, then the second user interface module 155 can be comprised of an appropriate portal or interface through which the user provides or otherwise enters information for use by the system 100. For example, the second user interface module 155 can be comprised of any suitable type of user interface capable of displaying graphical and/or textual information to a user. For example, the second user interface module 155 can be configured to display graphical and/or textual information generated by the system 100 through a suitable Web browser (e.g., Internet Explorer, Netscape, Firefox, Safari, Opera, or any other suitable Web browser) on any appropriate type of display, such as a computer monitor or other display device (e.g., a personal digital assistant (PDA) or the like portable display). However, the second user interface module 155 can provide any suitable type of electronic, computer, graphical and/or textual interface that is capable of allowing the second entity 110 to interface or otherwise interact with the system 100, depending on the type(s) of transactions supported by the system 100.

Once the second agent portal module 150 receives the authorization or fund retrieval code 140 from the second entity 110, the code (and any other appropriate information associated with the second fund transaction, such as information identifying the second entity 110) is routed to the transaction processor 130 via the transaction network 125. The transaction processor 130 is configured to perform appropriate processing on the second fund transaction. For purposes of illustration and not limitation, the transaction processor 130 can be configured to perform one or more compliance checks on or associated with the second fund transaction to ensure that the transaction complies with, for example, appropriate governmental regulations regarding such transactions. The transaction processor 130 is configured to approve the second fund transaction in accordance with the authorization or fund retrieval code 140. The approval can then be routed back to the second agent portal module 150 via the transaction network 125. Upon receiving the approval, the second agent portal module 150 is configured to supply or otherwise dispense the funds to the second entity 110 (e.g., in the second currency, if applicable) or otherwise cause those funds to be (electronically) stored in an account associated with the second entity 110.

To settle the second fund transaction, the transaction network 125 (e.g., using the settlement module 145) can be configured to settle the second transaction with the second agent portal module 150. For example, the settlement module 145 can settle the second fund transaction by (electronically) debiting funds from an account associated with the transaction processor 130 (as the funds were previously stored there) and crediting an account associated with the second agent portal module 150. The entire fund transaction is thereby completed according to exemplary embodiments.

The process of transferring or otherwise transmitting funds between the first and second entities 105 and 110 can be repeated any suitable number of times to transfer any desired amount of money or other funds between the parties. To facilitate further transfers, the first and second entities 105 and 110 can register with the system 100. For example, the first and second entities 105 and 110 can supply identifying information (e.g., name, address, telephone number, social security number, and the like) to create unique accounts with the system 100. Accordingly, the first agent portal module 115 can be configured to receive registration information from the first entity 105 for registering with the system 100, and the second agent portal module 150 can be configured to receive registration information from the second entity 110 for registering with the system 100. In response to registering, the first and second entities 105 and 110 can each receive a unique registration identifier, such as, for example, a username/password combination, a numerical or alphanumerical identifier, or the like. For example, the unique registration identifier can comprise a personal identification number (PIN) or the like. The first and second entities 105 and 110 can thereafter use the respective unique registration identifiers (e.g., the PINs) to interact with the system 100 to perform additional fund transfers without having to re-supply or re-enter account or other identifying information each time the system 100 is used. Rather, the account or other identifying information can be maintained or otherwise stored by the system 100 (e.g., in the database module 135) and retrieved using the unique registration identifiers of the first and second entities 105 and 110.

According to an exemplary embodiment, such unique registration identifiers can be encoded or otherwise stored securely on a suitable form of identification card, such as a form of a credit, debit, or smart card or other like storage medium that is capable of storing identifying information for later retrieval (e.g., a radio-frequency device, infrared device, or the like). Any or all registration information can be stored in, for example, the database module 135. The first and second agent portal modules 115 and 150 can each be configured to accept the identification cards from the first and second entities 105 and 110, respectively. For example, the first and/or second entities 105 and 110 can each have a card with a multi-digit number encoded on the respective card. For example, a terminal-based, card swipe solution or other suitable form of card or device reader can be used to accept the card or device. In other words, the first and second agent portal modules 115 and 150 can be configured to decode the unique registration identifier from the identification card for initiating the first and second fund transactions, respectively. To initiate the fund transfer, the first entity 105 can swipe its card through the reader, and enter the amount to be transferred (and the country indication, if applicable). The account or other identifying information for the first entity 105 can be retrieved from the database module 135 based on the decoded unique registration identifier. The first entity 105 can then be provided with a receipt or other record of the authorization or fund retrieval code 140. The second entity 110 can use its identification card and the authorization or fund retrieval code 140 to initiate the second fund transaction at the second location to retrieve the funds and complete the fund transfer process.

Each of modules of the system 100, including the first agent portal module 115, the first user interface module 120, the transaction network 125, the transaction processor 130, the database module 135, the settlement module 145, the second agent portal module 150, and the second user interface module 155, or any combination thereof, can be comprised of any suitable type of electrical or electronic component or device that is capable of performing the functions associated with the respective element. According to such an exemplary embodiment, each component or device can be in communication with another component or device using any appropriate type of electrical or electronic connection that is capable of carrying (e.g., electrical or electronic) information. Alternatively, each of the modules of the system 100 can be comprised of any combination of hardware, firmware and software that is capable of performing the functions associated with the respective module.

Alternatively, the system 100 can be comprised of one or more microprocessors and associated memory(ies) that store the steps of a computer program to perform the functions of any or all of the modules of the system 100. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming to perform the functions of any or all of the modules of the system 100. For example, the actual source code or object code of the computer program can be stored in the memory.

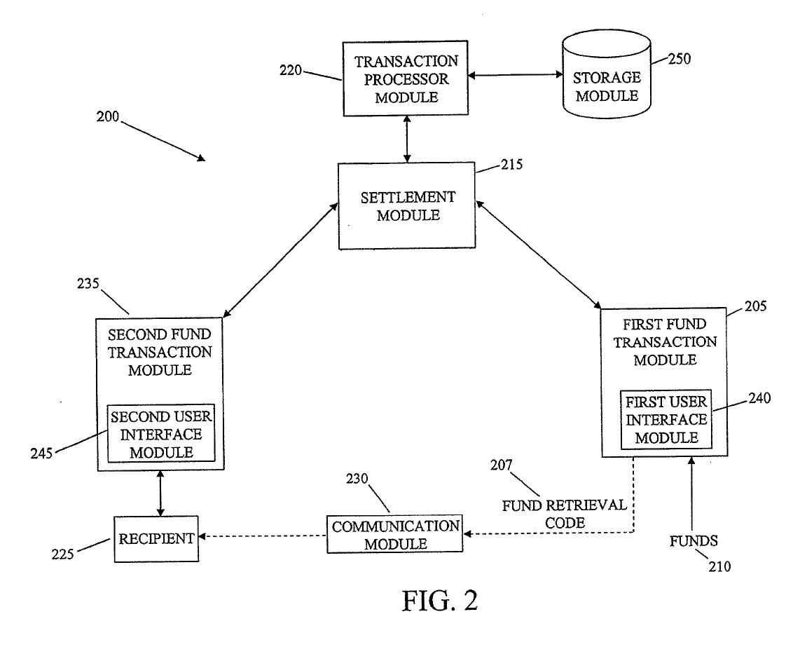

Alternative architectures or structures can be used to implement the various functions of the system 100 as described herein. For example, functions from two or more modules can be implemented in a single module, or functions from one module can be distributed among several different modules. In particular, the implementation of the functions of the system 100 can depend on the types of fund transactions supported by the system 100. Merely for purposes of illustration and not limitation, FIG. 2 is a block diagram illustrating a remittance system 200, in accordance with an alternative exemplary embodiment of the present invention. For example, the system 200 can be used for performing international fund transfers.

The system 200 includes a first fund transaction module 205. The first fund transaction module 205 is configured to receive funds 210 (e.g., electronic or cash tender) in a first currency for initiating a first fund transaction. Additionally, the first fund transaction module 205 is configured to receive an indication of a country to which the funds 210 will be transmitted. The system 200 includes a settlement module 215 in communication with the first fund transaction module 205. The first fund transaction module 205 is configured to route the first fund transaction to the settlement module 215. The settlement module 215 is configured to convert the funds 210 in the first currency to a second currency. The system 200 includes a transaction processor module 220 in communication with the settlement module 215. The settlement module 215 is configured to select the transaction processor module 220 for processing the fund transactions. The transaction processor module 220 is configured to supply a fund retrieval code 207 associated with the first fund transaction to the first fund transaction module 205. The transaction processor module 220 is also configured to store the funds 210 in the second currency while awaiting pickup. The fund retrieval code 207 is provided to a recipient 225 in a remote location (e.g., another country or region) via a communication module 230.

The communication module 230 is capable of communicating appropriate information to the recipient 225 via, for example, any suitable type of network, such as, for example, an intranet, an internet (e.g., the Internet or World Wide Web) or the like. According to an exemplary embodiment, the first fund transaction module 205 can be configured to communicate the fund retrieval code 207 to the recipient 225 (e.g., after the fund retrieval code 207 has been received from the transaction processor module 220) via the communication module 230. For example, an e-mail or other appropriate electronic message can be communicated to the recipient 225 (e.g., in a secure format) notifying the recipient 225 of the fund transaction and providing the fund retrieval code 207 for use by the recipient 225.

The system 200 includes a second fund transaction module 235 in communication with the settlement module 215. The second fund transaction module 235 is configured to receive the fund retrieval code 207 from the recipient 225 for initiating a second fund transaction. The second fund transaction module 235 is configured to route the fund retrieval code 207 received from the recipient 225 to the transaction processor module 220 via the settlement module 215. The transaction processor module 220 is configured to approve the second fund transaction in accordance with the fund retrieval code 207. Upon receipt of the approval from the transaction processor module 220, the second fund transaction module 235 is configured to dispense the funds 210 in the second currency to the recipient 225 or otherwise (electronically) deposit or store those funds 210 in an account associated with the recipient 225.

According to the alternative exemplary embodiment, the settlement module 215 is configured to settle the first fund transaction with the first fund transaction module 205, and to settle the second fund transaction with the second fund transaction module 235 (e.g., in the manners discussed previously). The settlement module 215 is also configured to determine the second currency into which the first currency is to be converted in accordance with the country indication. Furthermore, to facilitate interaction with the system 200, the first fund transaction module 205 can include a first user interface module 240, and the second fund transaction module 235 can include a second user interface module 245. To store any or all information provided to, used, or generated by the system 200, the system 200 can include a storage module 250 in communication with the transaction processor module 220.

Those of ordinary skill in the art will recognize that each of the modules of the systems 100 and 200 can be located locally to or remotely from each other, while use of the systems 100 and 200 as a whole still occurs within a given country, such as the United States. For example, merely for purposes of illustration and not limitation, the second agent portal module 150 (including the second user interface module 155) can be located extraterritorially to the United States (e.g., in Canada and/or in one or more other foreign countries). However, the first agent portal module 115 (including the first user interface module 120), the transaction network 125 (including settlement module 145), the transaction processor 130, and database module 135 can be located within the United States, such that the control of the system 100 as a whole is exercised and beneficial use of the system 100 is obtained by the user within the United States.

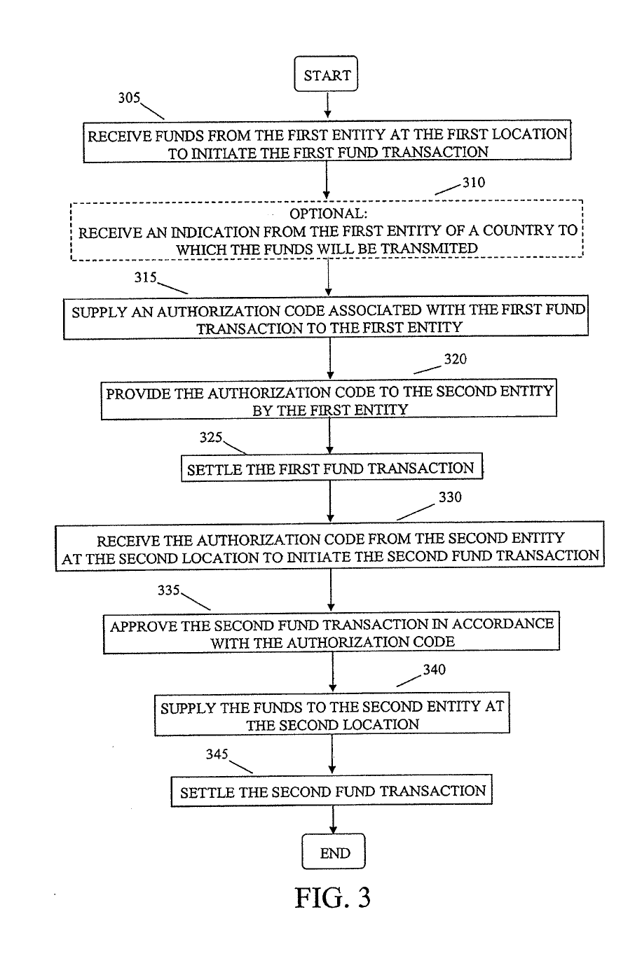

FIG. 3 is a flowchart illustrating steps for transmitting funds from a first entity to a second entity, in accordance with an exemplary embodiment of the present invention. In step 305, the funds are received from the first entity at a first location to initiate a first fund transaction. For international fund transfers, the funds received from the first entity can comprise a first currency, and the funds to be supplied to the second entity can comprise a second currency. Therefore, optionally in step 310, an indication of a country to which the funds will be transmitted can be received from the first entity. Accordingly, the funds can be converted from the first currency to the second currency. The second currency into which the first currency is to be converted can be determined in accordance with the country indication, for example, in the manner discussed previously. In addition, the first fund transaction is routed for processing. For example, compliance checks associated with the first fund transaction can be performed prior to supplying an authorization code. In step 315, an authorization code associated with the first fund transaction can be supplied to the first entity. The funds can then be stored (e.g., in the second currency) to await pickup by the second entity. In step 320, the authorization code is provided to the second entity by the first entity. In step 325, the first fund transaction is settled.

In step 330, the authorization code is received from the second entity at a second location to initiate a second fund transaction. The second fund transaction (including the authorization code) is routed for processing. For example, compliance checks associated with the second fund transaction can be performed prior to approving the second fund transaction. In step 335, the second fund transaction is approved in accordance with the authorization code. In step 340, the funds are supplied to the second entity at the second location (e.g., in the second currency). In step 345, the second fund transaction is settled to thereby complete the entire fund transfer process. According to exemplary embodiments, any suitable transaction information associated with the first and second fund transactions can be stored.

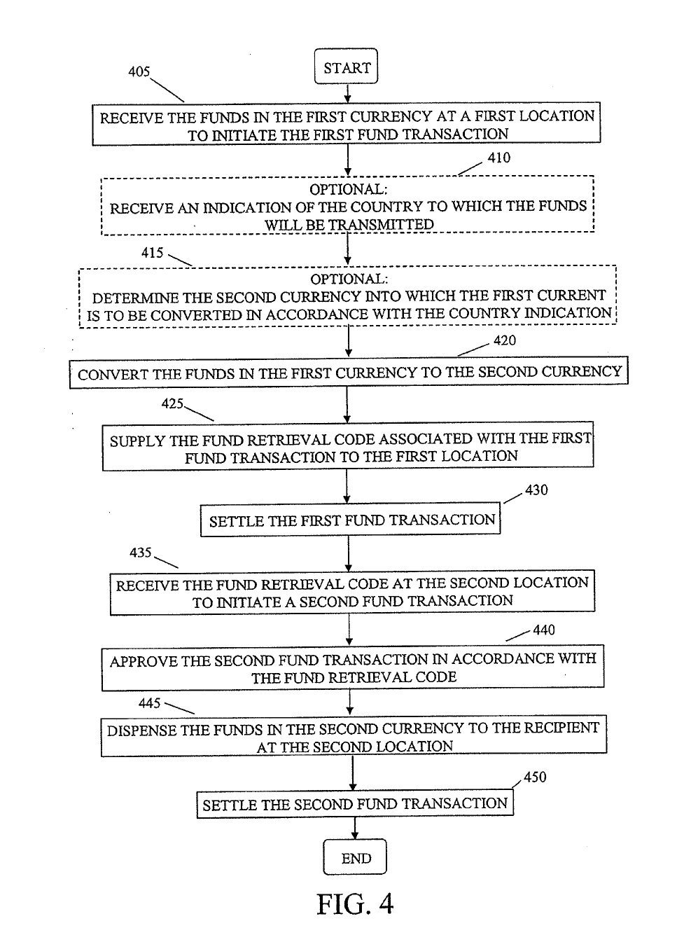

FIG. 4 is a flowchart illustrating steps for a remittance method, in accordance with an exemplary embodiment of the present invention. In step 405, funds are received in a first currency at a first location to initiate a first fund transaction. Optionally, in step 410, an indication of a country to which the funds will be transmitted can also be received. Optionally, in step 415, the second currency into which the first currency is to be converted can be determined in accordance with the country indication. In step 420, the funds in the first currency are converted to the second currency. In step 425, a fund retrieval code associated with the first fund transaction can be supplied to the first location. In step 430, the first fund transaction is settled. In step 435, the fund retrieval code is received at a second location to initiate a second fund transaction. In step 440, the second fund transaction is approved in accordance with the fund retrieval code. In step 445, the funds are dispensed in the second currency to a recipient at the second location. In step 450, the second fund transaction is settled.

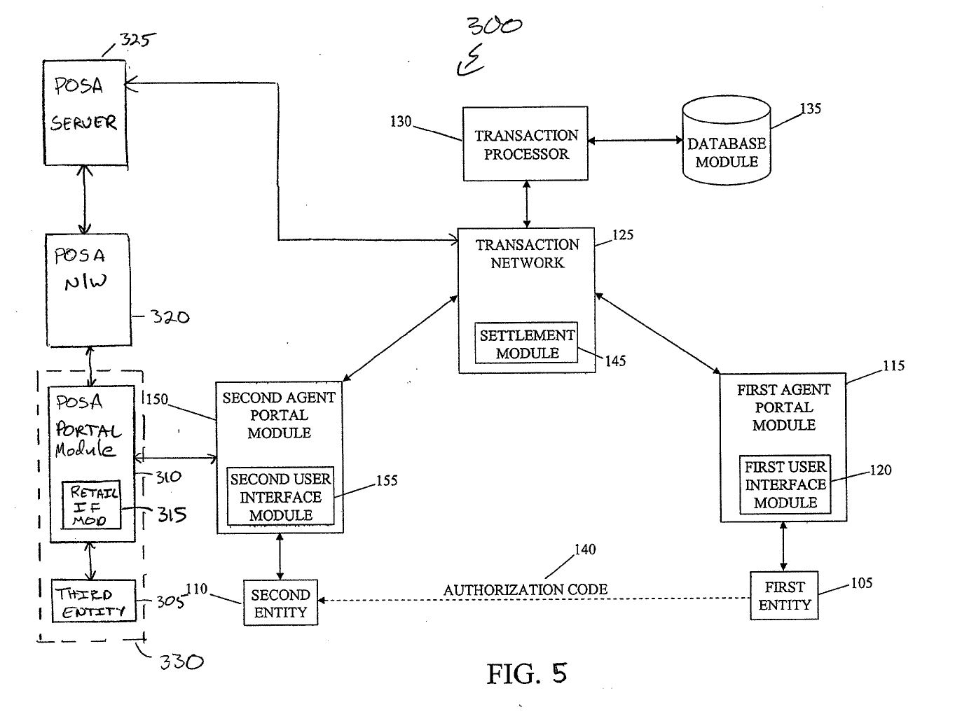

FIG. 5 illustrates a combined open network system and POSA system 300 according to an exemplary embodiment of the present invention. According to an exemplary embodiment, the system and method of the present invention uses an open network system to transfer funds globally. According to further exemplary embodiments of the present invention, POSA systems can be used on either the send side, the receive side, or both, and are connected into the open network system to facilitate transactions at retail locations. According to an exemplary embodiment of the present invention, the POSA system comprises POSA server 325 in communication with transaction network 125; POSA network 320; POSA portal 310 in communication with POSA network 320 and first agent portal module 115 and second agent portal module 155; retail interface (I/F) module 315 located preferably within POSA portal 310; and third entity 305 (i.e., customer of retail location 330).

To use system 300 according to an exemplary embodiment of the present invention, third entity 305 accesses a money transfer offering by interacting with retailer's 330 systems that are connected to the POSA system. The retailer system comprises POSA portal 310 and retail interface module 315. The POSA system server 325 receives a message from retailer 325 and submits the message to an open network system through connections (second portal module 150, and/or first agent portal module 115) and message formats that are typical for open network systems. The open network passes those messages as is currently standard and already contemplated and discussed by the current invention described in detail supra.

Each, all or any combination of the steps of a computer program as illustrated in FIGS. 3 and 4 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means or structure that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in conjunction with any device, system or process for performing money or fund transfers or other remittance operations from a first individual or organization (e.g., a first bank or other financial institution) to a second individual or organization (e.g., a second bank or other financial institution). For example, exemplary embodiments can be used for performing inter-regional or international fund transfers.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents and applications, and publications discussed above are hereby incorporated by reference herein in their entireties.

What is claimed is:

1. A system for transmitting funds from a first entity to a second entity, comprising:
a first agent portal module,
wherein the first agent portal module is configured to receive the funds from the first entity for initiating a first fund transaction;
a transaction network in communication with the first agent portal module;
a transaction processor in communication with the transaction network,
wherein the first fund transaction is routed to the transaction processor via the transaction network,
wherein the transaction processor is configured to supply an authorization code associated with the first fund transaction to the first entity via the transaction network and the first agent portal module, and
wherein the first entity is configured to provide the authorization code to the second entity; and
a second agent portal module in communication with the transaction network,
wherein the second agent portal module is configured to receive the authorization code from the second entity for initiating a second fund transaction,
wherein the authorization code is routed to the transaction processor via the transaction network,
wherein the transaction processor is configured to approve the second fund transaction in accordance with the authorization code, and
wherein, upon approval, the second agent portal module is configured to supply the funds to the second entity.

2. The system of claim 1, wherein the transaction network is configured to select the transaction processor for processing the first and second fund transactions.

3. The system of claim 1, wherein the transaction network comprises:
a settlement module.

4. The system of claim 3, wherein the settlement module is configured to settle the first fund transaction with the first agent portal module.

5. The system of claim 4, wherein the first fund transaction is settled by the settlement module by debiting funds from an account associated with the first agent portal module and crediting an account associated with the transaction processor.

6. The system of claim 3, wherein the settlement module is configured to settle the second fund transaction with the second agent portal module.

7. The system of claim 6, wherein the second fund transaction is settled by the settlement module by debiting funds from an account associated with the transaction processor and crediting an account associated with the second agent portal module.

8. The system of claim 1, wherein the first agent portal module comprises:
a first user interface module.

9. The system of claim 8, wherein the first user interface module is configured to interface the first entity to the first agent portal module.

10. The system of claim 8, wherein the first user interface module is configured to display a graphical interface through which the first entity interacts with the first agent portal module.

11. The system of claim 8, wherein the second agent portal module comprises:
a second user interface module.

12. The system of claim 11, wherein the second user interface module is configured to interface the second entity to the second agent portal module.

13. The system of claim 11, wherein the second user interface module is configured to display a graphical interface through which the second entity interacts with the second agent portal module.

14. The system of claim 1, further comprising:
a database module in communication with the transaction processor.

15. The system of claim 14, wherein the database module is configured to store transaction information associated with the first and second fund transactions.

16. The system of claim 1, wherein the funds are stored at the transaction processor.

17. The system of claim 1, wherein the funds received from the first entity comprise a first currency,
wherein the funds supplied to the second entity comprise a second currency, and
wherein the transaction network is configured to convert the funds from the first currency to the second currency.

18. The system of claim 17, wherein the funds are stored at the transaction processor in the second currency.

19. The system of claim 17, wherein the first agent portal module is configured to receive an indication from the first entity of a country to which the funds will be transmitted.

20. The system of claim 19, wherein the transaction network is configured to determine the second currency into which the first currency is to be converted in accordance with the country indication.

21. The system of claim 1, wherein the first agent portal module comprises a first unique identifier, and
wherein the first fund transaction is associated with the first unique identifier.

22. The system of claim 21, wherein the first unique identifier comprises a first bank identification number (BIN).

23. The system of claim 1, wherein the second agent portal module comprises a second unique identifier, and
wherein the second fund transaction is associated with the second unique identifier.

24. The system of claim 23, wherein the second unique identifier comprises a second bank identification number (BIN).

25. The system of claim 1, wherein the transaction processor is configured to perform a compliance check associated with the first fund transaction prior to supplying an authorization code.

26. The system of claim 1, wherein the transaction processor is configured to perform a compliance check associated with the second fund transaction prior to approving the second fund transaction.

27. The system of claim 1, wherein the first agent portal module is configured to receive registration information from the first entity for registering with the system.

28. The system of claim 27, wherein the first entity receives a unique registration identifier in response to registering with the system.

29. The system of claim 28, wherein the unique registration identifier comprises a personal identification number (PIN).

30. The system of claim 28, wherein the unique registration identifier is encoded on an identification card.

31. The system of claim 30, wherein the first agent portal module is configured to accept the identification card from the first entity, and
wherein the first agent portal module is configured to decode the unique registration identifier from the identification card for initiating the first fund transaction.

32. The system of claim 1, wherein the second agent portal module is configured to receive registration information from the second entity for registering with the system.

33. The system of claim 32, wherein the second entity receives a unique registration identifier in response to registering with the system.

34. The system of claim 1, wherein the first entity is in communication with the first agent portal module, and
wherein the second entity is in communication with the second agent portal module.

35. The system of claim 1, wherein the first agent portal module is located in a first remote location, and
wherein the second agent portal module is located in a second remote location.

36. The system of claim 1, wherein the first entity is configured to provide the authorization code to the second entity via a communication network.

37. A remittance system, comprising:
a first fund transaction module,
wherein the first fund transaction module is configured to receive funds in a first currency for initiating a first fund transaction;
a settlement module in communication with the first fund transaction module,
wherein the settlement module is configured to convert the funds in the first currency to a second currency;
a transaction processor module in communication with the settlement module,
wherein the transaction processor module is configured to supply a fund retrieval code associated with the first fund transaction to the first fund transaction module; and
a second fund transaction module in communication with the settlement module,
wherein the second fund transaction module is configured to receive the fund retrieval code from the first fund transaction module for initiating a second fund transaction,
wherein the transaction processor module is configured to approve the second fund transaction in accordance with the fund retrieval code, and
wherein, upon approval, the second fund transaction module is configured to dispense the funds in the second currency to a recipient.

38. The system of claim 37, wherein the first fund transaction module is configured to route the first fund transaction to the settlement module.

39. The system of claim 37, wherein the fund retrieval code is provided to the recipient via a communication module.

40. The system of claim 37, wherein the settlement module is configured to select the transaction processor module for processing the first and second fund transactions.

41. The system of claim 37, wherein the second fund transaction module is configured to route the fund retrieval code received from the recipient to the transaction processor module via the settlement module.

42. The system of claim 37, wherein the settlement module is configured to settle the first fund transaction with the first fund transaction module, and
wherein the settlement module is configured to settle the second fund transaction with the second fund transaction module.

43. The system of claim 37, wherein the first fund transaction module comprises:
a first user interface module.

44. The system of claim 43, wherein the second fund transaction module comprises:
a second user interface module.

45. The system of claim 37, comprising:
a storage module in communication with the transaction processor module.

46. The system of claim 37, wherein the transaction processor module is configured to store the funds in the second currency.

47. The system of claim 37, wherein the first fund transaction module is configured to receive an indication of a country to which the funds will be transmitted.

48. The system of claim 47, wherein the settlement module is configured to determine the second currency into which the first currency is to be converted in accordance with the country indication.

49. A computer-implemented method of transmitting funds from a first entity to a second entity, comprising the steps of:
a.) receiving the funds from the first entity at a first location to initiate a first fund transaction;
b.) supplying an authorization code associated with the first fund transaction from a transaction processor to the first entity;
c.) providing the authorization code to the second entity by the first entity;
d.) receiving the authorization code from the second entity at a second location to initiate a second fund transaction;
e.) approving the second fund transaction in accordance with the authorization code; and
f.) supplying the funds to the second entity at the second location.

50. The method of claim 49, further comprising the step of:
g.) routing the first fund transaction from step (a) for processing.

51. The method of claim 50, further comprising the step of
h.) routing the authorization code from step (d) for processing.

52. The method of claim 49, further comprising the step of:
g.) settling the first fund transaction.

53. The method of claim 49, further comprising the step of:
g.) settling the second fund transaction.

54. The method of claim 49, further comprising the step of
g.) storing transaction information associated with the first and second fund transactions.

55. The method of claim 49, further comprising the step of:
g.) storing the funds after step (b).

56. The method of claim 49, wherein the funds received from the first entity comprise a first currency,
wherein the funds supplied to the second entity comprise a second currency, and
wherein the method comprises the step of:
g.) converting the funds from the first currency to the second currency.

57. The method of claim 56, further comprising the step of:
h.) storing the funds in the second currency.

58. The method of claim 56, wherein step (a) comprises the step of
a1.) receiving an indication from the first entity of a country to which the funds will be transmitted.

59. The method of claim 58, wherein step (g) comprises the step of:
g1.) determining the second currency into which the first currency is to be converted in accordance with the country indication.

60. The method of claim 49, wherein the first fund transaction is associated with a first unique identifier.

61. The method of claim 60, wherein the first unique identifier comprises a first bank identification number (BIN).

62. The method of claim 49, wherein the second fund transaction is associated with a second unique identifier.

63. The method of claim 62, wherein the second unique identifier comprises a second bank identification number (BIN).

64. The method of claim 49, further comprising the step of:
g.) performing a compliance check associated with the first fund transaction prior to supplying an authorization code.

65. The method of claim 49, further comprising the step of:
g.) performing a compliance check associated with the second fund transaction prior to approving the second fund transaction.

66. The method of claim 49, wherein step (a) comprises the step of:
a1.) receiving registration information from the first entity.

67. The method of claim 66, wherein the first entity receives a unique registration identifier in response to step (a1).

68. The method of claim 67, wherein the unique registration identifier comprises a personal identification number (PIN).

69. The method of claim 67, wherein the unique registration identifier is encoded.

70. The method of claim 69, further comprising the step of:
g.) decoding the unique registration identifier to initiate the first fund transaction.

71. The method of claim 49, wherein step (d) comprises the step of:
d1.) receiving registration information from the second entity.

72. The method of claim 71, wherein the second entity receives a unique registration identifier in response to step (d1).

73. The method of claim 49, wherein the first location comprises a first remote location, and
wherein the second location comprises a second remote location.

74. A computer-implemented remittance method, comprising the steps of:
a.) receiving funds in a first currency at a first location to initiate a first fund transaction;
b.) converting the funds in the first currency to a second currency;
c.) supplying a fund retrieval code associated with the first fund transaction from a transaction processor to the first location;
d.) settling the first fund transaction and providing the fund retrieval code from the first location to a second location;
e.) receiving the fund retrieval code at the second location to initiate a second fund transaction;
f.) approving the second fund transaction in accordance with the fund retrieval code;
g.) dispensing the funds in the second currency to a recipient at the second location; and
h.) settling the second fund transaction.

75. The method of claim 74, wherein step (a) comprises the steps of:
a1.) receiving an indication of a country to which the funds will be transmitted; and
a2.) determining the second currency into which the first currency is to be converted in accordance with the country indication.

76. The method of claim 74, further comprising the step of:
i.) storing the funds in the second currency after step (b).

77. A computer-implemented method of transmitting funds, comprising the steps of:
a.) initiating a first fund transaction,
wherein step (a) comprises the steps of:
a1.) receiving the funds from a first entity at a first location; and
a2.) supplying a fund retrieval code associated with the first fund transaction from a transaction processor to the first entity;
b.) providing the fund retrieval code from the first entity to a second entity by the first entity; and
c.) initiating a second fund transaction,
wherein step (c) comprises the steps of:
c1.) receiving the fund retrieval code from the second entity at a second location;
c2.) approving the second fund transaction in accordance with the fund retrieval code; and
c3.) supplying the funds to the second entity at the second location.

78. A system for transmitting funds between a first entity and a second entity, comprising:
a first interfacing structure,
wherein the first interfacing structure is configured to receive the funds from the first entity for initiating a first fund transaction;
a networking transaction structure in communication with the first interfacing structure;
a processing transactions structure in communication with the transaction networking structure,
wherein the first fund transaction is routed to the transaction processing structure via the transaction networking structure,
wherein the transaction processing structure is configured to supply an authorization code associated with the first fund transaction to the first entity via the transaction networking structure and the first interfacing structure, and
wherein the first entity is configured to provide the authorization code to the second entity; and
a second interfacing structure in communication with the transaction networking structure,
wherein the second interfacing structure is configured to receive the authorization code from the second entity for initiating a second fund transaction,
wherein the authorization code is routed to the transaction processing structure via the transaction networking structure,
wherein the transaction processing structure is configured to approve the second fund transaction in accordance with the authorization code, and
wherein, upon approval, the second interfacing structure is configured to supply the funds to the second entity.

79. The system of claim 78, wherein the transaction networking structure is configured to select the transaction processing structure for processing the first and second fund transactions.

80. The system of claim 78, wherein the transaction networking structure comprises:
a settling transaction structure.

81. The system of claim 80, wherein the transaction settling structure is configured to settle the first fund transaction with the first interfacing structure.

82. The system of claim 81, wherein the first fund transaction is settled by the transaction settling structure by debiting funds from an account associated with the first interfacing structure and crediting an account associated with the transaction processing structure.

83. The system of claim 80, wherein the transaction settling structure is configured to settle the second fund transaction with the second interfacing structure.

84. The system of claim 83, wherein the second fund transaction is settled by the transaction settling structure by debiting funds from an account associated with the transaction processing structure and crediting an account associated with the second interfacing structure.

85. The system of claim 78, wherein the first interfacing structure is configured to interface to the first entity.

86. The system of claim 78, wherein the first interfacing structure is configured to display a graphical interface through which the first entity interacts with the first interfacing structure.

87. The system of claim 78, wherein the second interfacing structure is configured to interface to the second entity.

88. The system of claim 78, wherein the second interfacing structure is configured to display a graphical interface through which the second entity interacts with the second interfacing structure.

89. The system of claim 78, comprising:
a storing information structure in communication with the transaction processing structure.

90. The system of claim 89, wherein the information storing structure is configured to store transaction information associated with the first and second fund transactions.

91. The system of claim 78, wherein the funds are stored at the transaction processing structure.

92. The system of claim 78, wherein the funds received from the first entity comprise a first currency,
wherein the funds supplied to the second entity comprise a second currency, and
wherein the transaction networking structure is configured to convert the funds from the first currency to the second currency.

93. The system of claim 92, wherein the funds are stored at the transaction processing structure in the second currency.

94. The system of claim 92, wherein the first interfacing structure is configured to receive an indication from the first entity of a country to which the funds will be transmitted.

95. The system of claim 94, wherein the transaction networking structure is configured to determine the second currency into which the first currency is to be converted in accordance with the country indication.

96. The system of claim 78, wherein the first interfacing structure comprises a first unique identifier, and
wherein the first fund transaction is associated with the first unique identifier.

97. The system of claim 96, wherein the first unique identifier comprises a first bank identification number (BIN).

98. The system of claim 78, wherein the second interfacing structure comprises a second unique identifier, and
wherein the second fund transaction is associated with the second unique identifier.

99. The system of claim 98, wherein the second unique identifier comprises a second bank identification number (BIN).

100. The system of claim 78, wherein the transaction processing structure is configured to perform a compliance check associated with the first fund transaction prior to supplying an authorization code.

101. The system of claim 78, wherein the transaction processing structure is configured to perform a compliance check associated with the second fund transaction prior to approving the second fund transaction.

102. The system of claim 78, wherein the first interfacing structure is configured to receive registration information from the first entity for registering with the system.

103. The system of claim 102, wherein the first entity receives a unique registration identifier in response to registering with the system.

104. The system of claim 103, wherein, the unique registration identifier comprises a personal identification number (PIN).

105. The system of claim 103, wherein the unique registration identifier is encoded on an identification device.

106. The system of claim 105, wherein the first interfacing structure is configured to accept the identification device from the first entity, and
wherein the first interfacing structure is configured to decode the unique registration identifier from the identification device for initiating the first fund transaction.

107. The system of claim 78, wherein the second interfacing structure is configured to receive registration information from the second entity for registering with the system.

108. The system of claim 107, wherein the second entity receives a unique registration identifier in response to registering with the system.

109. The system of claim 78, wherein the first entity is in communication with the first interfacing structure, and
wherein the second entity is in communication with the second interfacing structure.

110. The system of claim 78, wherein the first interfacing structure is located in a first remote location, and
wherein the second interfacing structure is located in a second remote location.

111. The system of claim 78, wherein the first entity is configured to provide the authorization code to the second entity via a communicating structure.

112. A remittance system, comprising:
a first fund transaction performing structure,
wherein the first fund transaction performing structure is configured to receive funds in a first currency for initiating a first fund transaction;
a transaction settling structure in communication with the first fund transaction performing structure,
wherein the transaction settling structure is configured to convert the funds in the first currency to a second currency;
a transaction processing structure in communication with the transaction settling structure,
wherein the transaction processing structure is configured to supply a fund retrieval code associated with the first fund transaction to the first fund transaction performing structure; and
a second fund transaction performing structure in communication with the transaction settling structure,
wherein the second fund transaction performing structure is configured to receive the fund retrieval code from the first fund transaction performing structure for initiating a second fund transaction,
wherein the transaction processing structure is configured to approve the second fund transaction in accordance with the fund retrieval code, and
wherein, upon approval, the second fund transaction performing structure is configured to dispense the funds in the second currency to a recipient.

113. The system of claim 112, wherein the first fund transaction performing structure is configured to route the first fund transaction to the transaction settling structure.

114. The system of claim 112, wherein the fund retrieval code is provided to the recipient via a communicating structure.

115. The system of claim 112, wherein the transaction settling structure is configured to select the transaction processing structure for processing the first and second fund transactions.

116. The system of claim 112, wherein the second fund transaction performing structure is configured to route the fund retrieval code received from the recipient to the transaction processing structure via the transaction settling structure.

117. The system of claim 112, wherein the transaction settling structure is configured to settle the first fund transaction with the first fund transaction performing structure, and
wherein the transaction settling structure is configured to settle the second fund transaction with the second fund transaction performing structure.

118. The system of claim 112, wherein the first fund transaction performing structure comprises:
a first interfacing structure.

119. The system of claim 118, wherein the second fund transaction performing structure comprises:
a second interfacing structure.

120. The system of claim 112, comprising:
a storing information structure in communication with the transaction processing structure.

121. The system of claim 112, wherein the transaction processing structure is configured to store the funds in the second currency.

122. The system of claim 112, wherein the first fund transaction performing structure is configured to receive an indication of a country to which the funds will be transmitted.

123. The system of claim 122, wherein the transaction settling structure is configured to determine the second currency into which the first currency is to be converted in accordance with the country indication.

124. The system according to claim 1, wherein the system further comprises:
a point of sale activation system portal module,
wherein the point of sale activation system portal module is configured to receive a message from a customer requesting a transfer of funds;
a point of sale activation system network in communication with the point of sale activation system portal module;
a point of sale activation system server in communication with the transaction network, point of sale activation system server, and the point of sale activation system module,
wherein the point of sale activation system message can be routed to the transaction processor via the transaction network,
wherein the transaction processor is configured to supply an authorization code associated with message to the first entity via the transaction network and the first agent portal module, and
wherein the first entity is configured to provide the authorization code to the second entity; and
a second agent portal module in communication with the transaction network,
wherein the second agent portal module is configured to receive the authorization code from the second entity for initiating a second fund transaction,
wherein the authorization code is routed to the transaction processor via the transaction network,
wherein the transaction processor is configured to approve the second fund transaction in accordance with the authorization code, and
wherein, upon approval, the second agent portal module is configured to supply the funds to the customer via the point of sale activation system portal module.
